(19) United States
(12) Patent Application Publication
(10) Pub. No.: US 2014/0265305 A1
(43) Pub. Date: Sep. 18, 2014

(54) CONDUIT COUPLING SYSTEM AND METHOD

(71) Applicant: Steven L. Thompson, Girard, KS (US)

(72) Inventor: Steven L. Thompson, Girard, KS (US)

(21) Appl. No.: 14/216,233

(22) Filed: Mar. 17, 2014

Related U.S. Application Data
(60) Provisional application No. 61/788,645, filed on Mar. 15, 2013.

(51) Int. Cl. F16L 19/04

(52) U.S. Cl. CPC F16L 19/043
USPC 285/89

(57) ABSTRACT

A conduit coupling construction including a coupling body threadably mounting a pair of lock nuts on its ends. Conduit ends are passed through the lock nuts and into the coupling body. Each lock nut receives a respective lock ring adapted for compression onto a respective conduit. The lock ring transforms an axial force on the conduit to a shear force to enhance gripping for pull-out resistance. The central body portion is transparent and allows an end of a conduit to pass completely through the body for more convenient installation onto two separated pieces of conduit, thereby joining them. This construction allows the coupler to be slipped over a first conduit section, aligned with a second conduit section, and the two sections joined without the need to bend either conduit.

### CROSS-REFERENCE TO RELATED APPLICATION

This application claims priority in U.S. Provisional Patent Application No. 61/788,645 filed Mar. 15, 2013, which is incorporated herein by reference.

### BACKGROUND OF THE INVENTION

1. Field of the Invention

The present invention relates generally to couplings, and in particular to pipe couplings with lock ring constructions providing resistance to the coupled pipes and conduits from being pulled out of the couplings.

2. Description of the Related Art

Couplings and fittings of various types are used for joining pipes and conduits. For example, Thompson U.S. Pat. No. 5,180,197 discloses a pipe jointing system with a tubular coupling having a rigid, outer layer receiving an elastomeric inner layer having annular ridges for pull-out resistance and sealing. Thompson U.S. Pat. No. 5,833,276 discloses a double-ended coupling with lock rings adapted for compression onto the pipe ends by lock nuts, which are threaded onto the coupling body ends. The compressive forces imparted by the lock rings restrain the pipe ends within the coupling body.

There is a significant demand for couplings that can join conduit without solvent, adhesive bonding, fusion welding or special installation equipment. For example, electrical and telecommunications conduits are commonly joined by such couplings and fittings. In recent years fiber optic cable networks have been installed in many parts of the country. Such networks are commonly buried, thus creating significant demand for couplings adapted to permanently join sections of plastic (e.g., HDPE, etc.) conduit in below-grade conditions. The fiber optic cables are commonly blown through the conduit by pressurized air, whereby the conduits and their fittings have to be able to withstand air pressures of 100 PSI or more. Water-tightness is another criterion for many such subsurface telecommunications conduit installations, which must prevent groundwater infiltration. Therefore, fiber optic cable conduit fittings are preferably fluid-tight and provide considerable resistance to pull-out. It is also preferred that they be adapted for efficient installation without tools or solvent adhesives.

Conduit sections can also be securely coupled together by providing each section with an enlarged, bell end for telescopically receiving the corresponding end of an adjacent conduit section. Similar performance criteria, such as fluid-tight construction and pull out resistance, apply to such self-joining conduit sections when they are used for fiber optic cables and other, similar applications.

Common conduit couplings for joining the ends of two adjacent conduits, such as the one described in detail in U.S. Pat. No. 5,833,276 above, and other common couplings, require an extensive amount of work to join two adjacent conduit ends using such a coupling. The typical coupling includes a “stop” or a guard in the center of the coupling. The purpose of this stop is to prevent the coupling from sliding off of one conduit end and onto another. However, this stop makes it difficult to install the coupling, and does not completely ensure that the coupling cannot slide off of either conduit end.

Heretofore there has not been available a conduit coupler system or method with the advantages and features of the present invention.

### SUMMARY OF THE INVENTION

In the practice of one aspect of the present invention, a conduit coupling construction includes a coupling body threadably mounting a pair of lock nuts on its ends. Conduit ends are passed through the lock nuts and into the coupling body. Each lock nut receives a respective lock ring adapted for compression onto a respective conduit. The lock ring transforms an axial force on the conduit to a shear force to enhance gripping for pull-out resistance. The central body portion is transparent and allows an end of a conduit to pass completely through the body for more convenient installation onto two separated pieces of conduit, thereby joining them.

### BRIEF DESCRIPTION OF THE DRAWINGS

The drawings constitute a part of this specification and include exemplary embodiments of the present invention illustrating various objects and features thereof

FIG. 1 is an isometric view of an embodiment of the present invention.

FIG. 2 is a side elevational view demonstrating the components of an embodiment of the present invention.

FIG. 3 is a side sectional elevational view demonstrating an embodiment of the present invention as installed on two pieces of conduit.

FIG. 4 is a side sectional view of an embodiment of the present invention, demonstrating the lock ring element.

FIG. 5 is a side sectional view of the same, demonstrating the lock ring element after the coupler end cap has been tightened.

FIGS. 6A-6F demonstrate the steps to a method of coupling together the ends of two adjacent conduits using an embodiment of the present invention.

FIGS. 7A-7D demonstrate the steps to a method of coupling together the ends of two adjacent conduits using the prior art.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment or Aspect Conduit Coupling System 2

Referring to the drawings in more detail; the numeral 2 generally refers to a conduit coupling system capable of joining a first conduit end 26 with a second conduit end 28, thereby establishing a continuous length of conduit for wiring, fiber optic cable, or other common uses. Generally, this joining of two conduit ends occurs where the end of one length of conduit meets the beginning of the next length of conduit, though it could also occur at a break in a single piece of conduit, or used to join a piece of conduit that was purposefully split for repair or replacement purposes.

FIG. 1 shows the three main components to a conduit coupling system 2, including the housing body 4, the lock ring 14, and a pair of caps 20 (only one shown). The housing body 4 includes a housing chamber 6 which is preferably semi-transparent to allow the user to view the ends of conduit sections within the body 4. Each end of the housing body includes a chamber opening 12 and a number of housing threads 8. A gasket 10 is inserted into each opening 12 of the housing body 4.

The lock ring 14 includes an opening 16 which allows the ring to accept a conduit and then compress around the conduit as the lock ring is closed. A number of gripping teeth 18 are molded into the inner face of the ring 14. A preferred embodiment of the locking ring 14 would include a foot 15 which allows the ring to sit against the edge of the housing body 4 or gasket 10.

Each cap 20 includes a plurality of internal threads 24 which are adapted to engage with the outer threads 8 of the housing body 4. A preferred embodiment of a cap 20 also includes a number of grips 22 which make tightening and loosening the cap 20 onto the housing body threads 8 easier on the user.

FIGS. 2 and 3 demonstrate the interaction between the conduit coupling system 2 and the ends of a first conduit 26 and a second conduit 28. The caps 20 and lock rings 14 slide over the conduit ends, which are then placed into the housing body 4. The housing body is transparent, as shown in FIG. 3, allowing the operator to ensure the conduit is lined up within the body. The caps 20 are then threaded onto the body 4 via their respective threads 24, 8. As the cap is tightened, the lock ring 14 compresses around the conduit, preventing it from being pulled out of the coupler system 2. This is shown in more detail in FIGS. 4 and 5.

FIGS. 6A-6F demonstrate a method of coupling the ends of two conduits 26, 28 with the coupler system 2. In contrast, FIGS. 7A-7D demonstrate how such a connection is made using a prior art coupler 52. The present invention, as shown in FIGS. 6A-6F, does not have a “stop” or a “block” located within the central chamber 6. This allows the conduit 26 to slide completely through the center of the housing body 4. This allows the installer to more easily install the conduit coupler system 2 than previous conduit couplers.

As shown in FIGS. 7A-7D, previous conduit coupler systems 52 require the user to bend two conduit ends 62, 64 to accommodate the stop 57 located within the housing chamber 56 of the housing body 54. This can be difficult with rigid conduit or conduit which has been incorrectly cut, requiring the installer to remove the system 52, cut the conduit 62, 64 to fit, and reinstall the system 52. The caps 60 are threaded onto the threaded ends 58 of the housing body 54, but do not prevent the conduit from being pulled out if the system 52 shifts one direction or the other along the conduit. This requires the stop 57 in the center to prevent sliding of the coupler system 52.

The present invention does not have a stop, thereby making installation easier. However, without a stop, the coupler system 52 could travel along one conduit or another as the conduits shrink and expand to heat, or while being adjusted for other purposes. The locking rings 14 are therefore outfitted with gripping teeth 18 which prevent the conduit from sliding once the caps have fully engaged the housing body 4, thereby clamping the lock rings firmly down onto the conduit. In short: the conduit cannot “pull out,” and the conduit coupler system 2 cannot travel from one conduit end onto the other.

It is to be understood that while certain embodiments and/or aspects of the invention have been shown and described, the invention is not limited thereto and encompasses various other embodiments and aspects.

Having thus described the disclosed subject matter, what is claimed as new and desired to be secured by Letters Patent is:

1. A coupling for a conduit section having a conduit section end, said coupling comprising:
a coupling body including an outer casing, a first open end, and a coupling passage within said body receiving a first conduit section and terminating at said body first open end, said passage being free from any obstructions;
an axial axis running through the center of said passage and generally in the direction of alignment of said first conduit section;
said coupling body comprising a semi-transparent material;
external threading on an external face of said coupling body located adjacent to said first open end of said body;
a lock nut including a proximate end, a distal end, and a lock nut passage extending between and open at said proximal end and said distal end;
said lock nut passage having an internally-threaded proximate section adjacent to said lock nut proximate end and a distal section converging distally from said passage proximate section to said lock nut distal end;
said lock nut passage having a proximate diameter adjacent to its proximate end and a reduced, distal diameter adjacent to its distal end;
a lock ring including a generally frusto-conical outer surface with a configuration corresponding to the configuration of the lock nut passage converging distal section, a proximate end with a first diameter, a distal end with a second diameter smaller than said first diameter, and a lock ring passage extending between and open at said lock ring proximal end and distal end;
an interior surface of said lock ring configured to provide an increased frictional interface with said first conduit section; and
wherein said lock ring is further configured to slip axially with respect to said lock nut such that the diameter of said lock ring passage is adjusted.

2. The coupling of claim 1, further comprising:
said coupling body including a second open end, said coupling passage also terminating at said second open end;
external threading on an external face of said coupling body located adjacent to said second open end of said body; and
wherein one said lock nut and one said lock ring is located at said first end, and one said lock nut and one said lock ring is located at said second end.

3. The coupling of claim 2, further comprising:
a second conduit section inserted through said second open end;
said first conduit section and said second conduit section each comprising a conduit end; and
wherein said conduit ends are viewable through said coupling body.

4. The coupling of claim 1 wherein said lock ring includes a diameter control slot which expands and contracts respectively as said lock nut advances proximally and distally with respect to said lock ring.

5. The coupling of claim 1 wherein said casing includes an outer surface and a plurality of radially-spaced grips projecting outwardly from said casing outer surface and positioned proximally from said external threading.

6. The coupling of claim 1 wherein said lock nut includes a lock nut outer surface and a plurality of radially-spaced grips projecting outwardly from said lock nut outer surface.

7. A method of coupling a first conduit section to a second conduit section, the method comprising the steps:
sliding a first lock nut over a first conduit section end, said lock nut including a proximate end, a distal end, and a lock nut passage extending between and open at said proximal end and said distal end;
placing a first lock ring over said first conduit section end, said lock ring including a generally frusto-conical outer surface with a configuration corresponding to the configuration of the lock nut passage converging distal section, a proximate end with a first diameter, a distal end with a second diameter smaller than said first diameter, and a lock ring passage extending between and open at said lock ring proximal end and distal end;
inserting said first conduit section end into a first open end of a coupling body comprising an outer casing and a coupling passage within said body beginning at a body second open end and terminating at said body first open end, said passage being free from any obstructions;
wherein said coupling body comprises a semi-transparent material;
sliding said coupling body over said first conduit section such that said first conduit section end is in proximity to said body second open end;
aligning a second conduit section end with said first conduit section end;
inserting an end of a second conduit section into said second open end;
placing a second lock nut and a second lock ring over said second conduit section end;
sliding said coupling body over said second conduit section such that said first conduit section end and said second conduit section end are adjacent to one another and are generally centrally located within said coupling passage;
threading said first lock nut onto external threading on an external face of said coupling body adjacent to said first open end of said body, thereby tightening said first lock ring against said first conduit section; and
threading said second luck nut onto external threading on an external face of said coupling body adjacent to said second open end of said body, thereby tightening said second lock ring against said second conduit section.

8. The method according to claim 7, wherein said lock nut passage includes an internally-threaded proximate section adjacent to said lock nut proximate end and a distal section converging distally from said passage proximate section to said lock nut distal end.

9. The method according to claim 8, wherein said lock nut passage includes a proximate diameter adjacent to its proximate end and a reduced, distal diameter adjacent to its distal end.

10. The method according to claim 7, wherein an interior surface of said lock ring is configured to provide an increased frictional interface with said first conduit section.

11. The method according to claim 10, wherein said lock ring is further configured to slip axially with respect to said lock nut such that the diameter of said lock ring passage is adjusted.

12. The method according to claim 11 wherein said lock ring includes a diameter control slot which expands and contracts respectively as said lock nut advances proximally and distally with respect to said lock ring.

13. The method according to claim 7, wherein said casing includes an outer surface and a plurality of radially-spaced grips projecting outwardly from said casing outer surface and positioned proximally from said external threading.

14. The method according to claim 7, wherein said lock nut includes a lock nut outer surface and a plurality of radially-spaced grips projecting outwardly from said lock nut outer surface.
